(19) United States
(12) Patent Application Publication
(10) Pub. No.: US 2012/0020089 A1
(43) Pub. Date: Jan. 26, 2012

(54) LIGHT EMITTING DIODE LIGHT BAR

(75) Inventors: MIN-TSUN HSIEH, Hsinchu (TW); WEN-LIANG TSENG, Hsinchu (TW); LUNG-HSIN CHEN, Hsinchu (TW); CHIH-YUNG LIN, Hsinchu (TW); CHING-LIEN YEH, Hsinchu (TW); CHI-WEI LIAO, Hsinchu (TW)

(73) Assignee: ADVANCED OPTOELECTRONIC TECHNOLOGY, INC., Hsinchu Hsien (TW)

(21) Appl. No.: 13/074,016

(22) Filed: Mar. 29, 2011

(30) Foreign Application Priority Data
Jul. 23, 2010 (CN) 201020269497.4

(51) Int. Cl. F21S 4/00

(52) U.S. Cl. 362/249.06

(57) ABSTRACT

An LED light bar includes an elongated circuit board, a first lighting module formed in the middle of the circuit board and two second light modules formed at two opposite ends of the circuit board. Each of first lighting module and the two second lighting module includes a plurality of LEDs arranged linearly on a surface of the circuit board. A density of the LEDs in the first lighting module is smaller than that in the second lighting modules.

### TECHNICAL FIELD

The disclosure generally relates to light emitting diode (LED) light bars, especially to an LED light bar with uniform light distribution.

### DESCRIPTION OF RELATED ART

In recent years, due to excellent light quality and high luminous efficiency, light emitting diodes (LEDs) have increasingly been used to substitute for incandescent bulbs or compact fluorescent lamps or fluorescent tubes as a light source of an illumination device.

Referring to FIG. 1, a related LED light bar 100 generally includes an elongated circuit board 110 and a plurality of LEDs 121 arranged linearly on the circuit board 110. Intervals between adjacent LEDs 121 are the same and this causes the LED light bar 100 to have an uneven light distribution. In addition, the heat generated by the LEDs 121 is easy to concentrate in the middle of the LED light bar 100, whereby the life of the LED light bar 100 is shortened.

Therefore, an improved LED light bar is desired to overcome the above described shortcomings

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a side view of an LED light bar in accordance with related art.

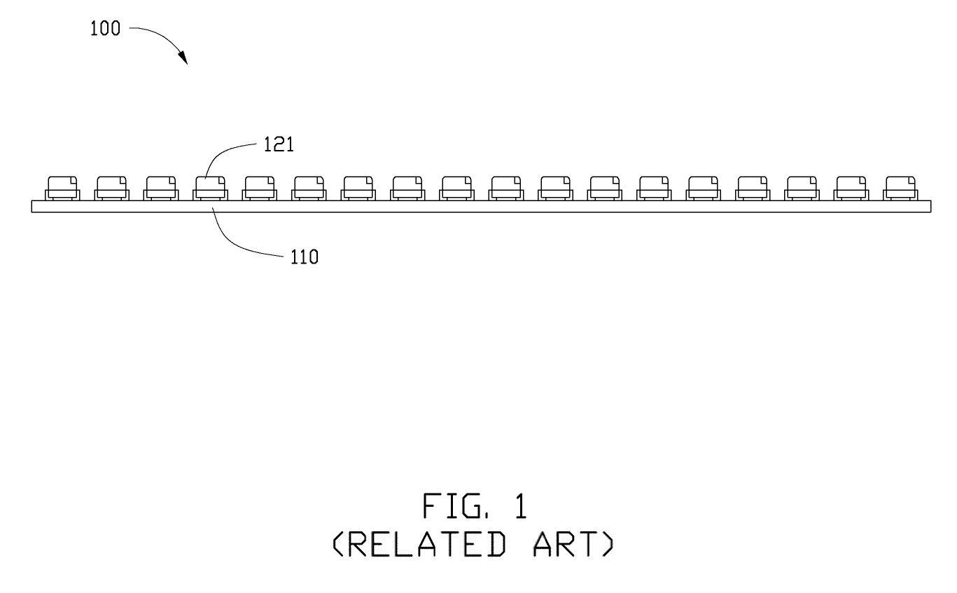

FIG. 2 shows a side view of an LED light bar in accordance with a first embodiment.

FIG. 3 shows a top view of the LED light bar in FIG. 2.

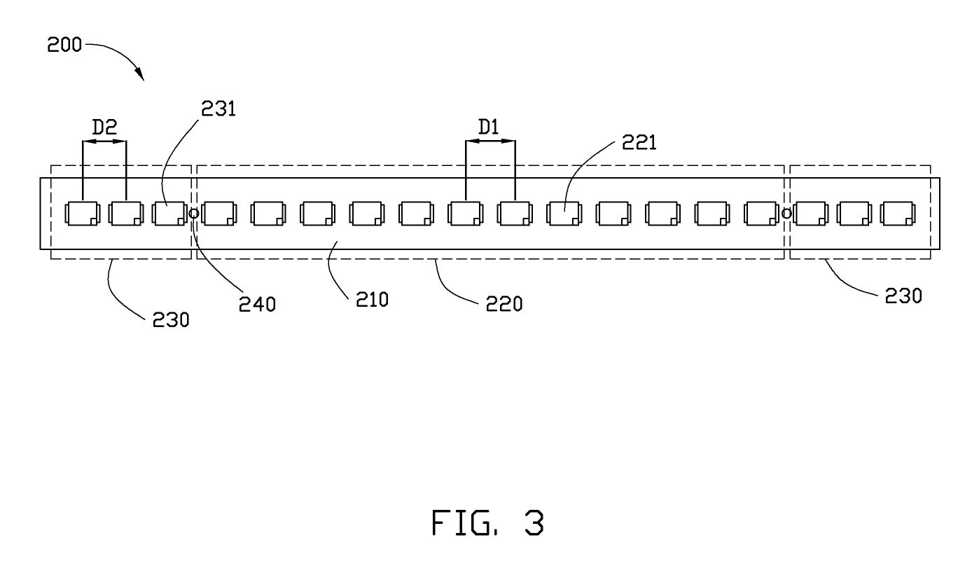

FIG. 4 shows a side view of an LED light bar in accordance with a second embodiment.

FIG. 5 shows a side view of an LED light bar in accordance with a third embodiment.

FIG. 6 shows a side view of an LED light bar in accordance with a fourth embodiment.

### DETAILED DESCRIPTION

Embodiments of the LED light bars will now be described in detail below and with reference to the drawings.

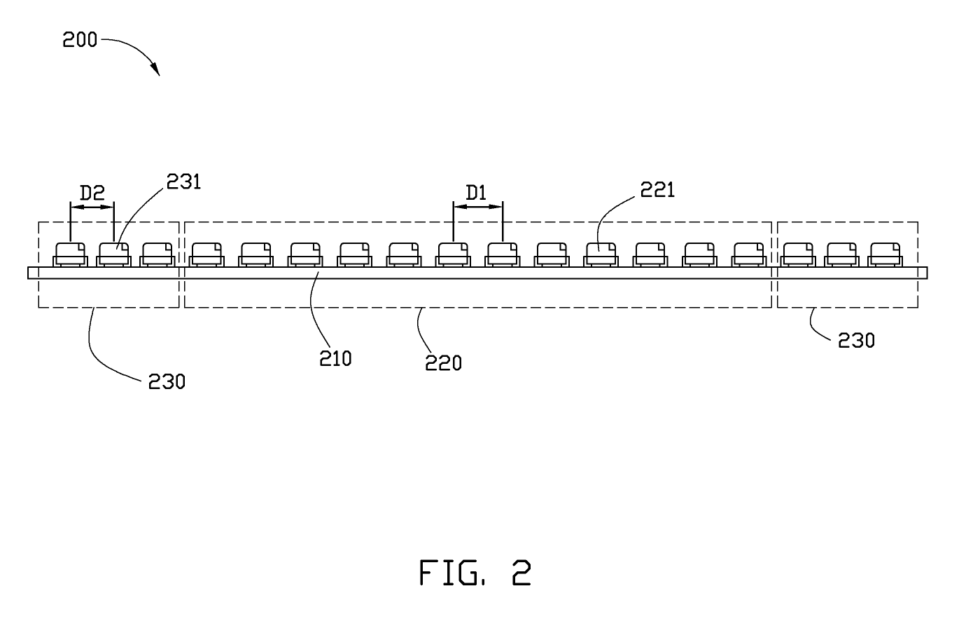

Referring to FIG. 2, an LED light bar 200 in accordance with a first embodiment includes an elongated circuit broad 210, a first lighting module 220 and two second lighting modules 230 formed on the circuit broad 210.

The circuit broad 210 includes a base (not labeled) and a conductive layer (not labeled) formed on a surface of the base. The base can be made of semiconductor, ceramic or metallic materials. In this embodiment, the circuit broad 210 is Al-based printed circuit broad and the heat generated by the first lighting module 220 and the second lighting modules 230 can be efficiently transferred to the Al-base and dissipated to the environment. In this embodiment, the circuit broad 210 includes two holes 240 defined in areas between the first lighting module 220 and the second lighting modules 230. The holes 240 are used for extension of screws (not shown) therethrough for fixing the LED light bar 200 to an LED tube housing (not shown) and distinguishing and separating the first lighting module 220 from the second lighting modules 230.

The first lighting module 220 is formed in the middle of the circuit board 210. The first lighting module 220 includes a plurality of LEDs 221 arranged linearly on a surface of the circuit broad 210. The LEDs 221 can be surface mounting devices (SMD), and electrodes of the LEDs 221 are electrically connected to the external power by the conductive layer on the circuit board 210. The LEDs 221 can be in series connection or in parallel connection. In this embodiment, intervals between the adjacent LEDs 221 in the first lighting module 220 are the same and the intervals each are represented by D1. In the present embodiment, the value of D1 is 10.3 mm.

The two second lighting modules 230 are formed at two opposite ends of the circuit board 210, and the two second lighting modules 230 can be in series connection or in parallel connection with the first lighting module 220. Each second lighting module 230 includes a plurality of LEDs 231 arranged linearly on the circuit broad 210. Similar to the first lighting module 220, intervals between the adjacent LEDs 231 in the second lighting modules 230 are the same and the intervals each are represented by D2. The intervals D2 between adjacent LEDs 231 are less than the D1 between adjacent LEDs 221. In this embodiment, the value of D2 is 8.8 mm.

Because the interval D2 is smaller than the interval D1, the arrangement density of the LEDs 221 in the middle of the circuit board 210 is smaller than that of the LEDs 231 in the two opposite ends of the circuit board 210, and a uniform lighting distribution is thus achieved. In addition, because the LEDs 221 in the first lighting module 220 are spaced by a long distance, the heat generated by the LEDs 221 will not be concentrated in the middle of the circuit board 210.

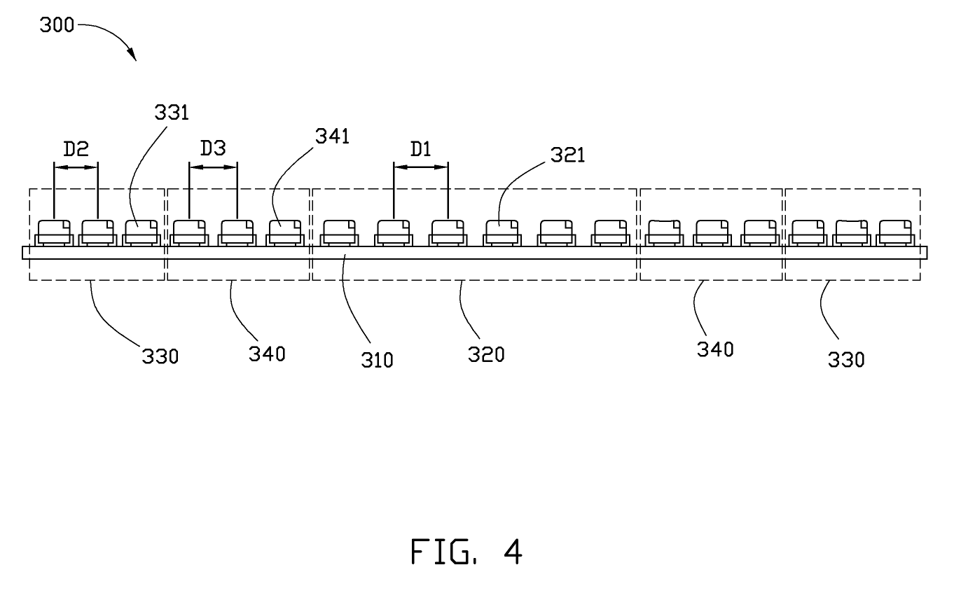

Referring to FIG. 4, an LED light bar 300 in accordance with a second embodiment includes an elongated circuit board 310, a first lighting module 320, two second lighting modules 330 and two third lighting modules 340 formed on a surface of the circuit board 310. The first lighting module 320 is formed in the middle of the circuit broad 310, and the two second lighting modules 330 are formed at two opposite ends of the circuit board 310. The two third lighting modules 340 are formed between the first lighting module 320 and the two second lighting modules 330 respectively.

The first lighting module 320 includes a plurality of LEDs 321 and intervals between the LEDs 321 each are represented by D1. The second lighting module 330 includes a plurality of LEDs 331 and intervals between the LEDs 331 each are represented by D2. The third lighting module 340 includes a plurality of LEDs 341 and intervals between the LEDs 341 each are represented by D3. The LEDs 321, 331 and 341 are arranged linearly on a surface of the circuit board 310 in accordance with following relationship: D1>D3>D2. In this embodiment, the value of D1 is 10.65 mm; the value of D2 is 8.55 mm; and the value of D3 is 9.75 mm. In alternative embodiments, the LED light bar 300 can further include holes defined between the adjacent lighting modules for fixing the circuit board 310 to the LED tube housing and for users to distinguish one lighting module from another.

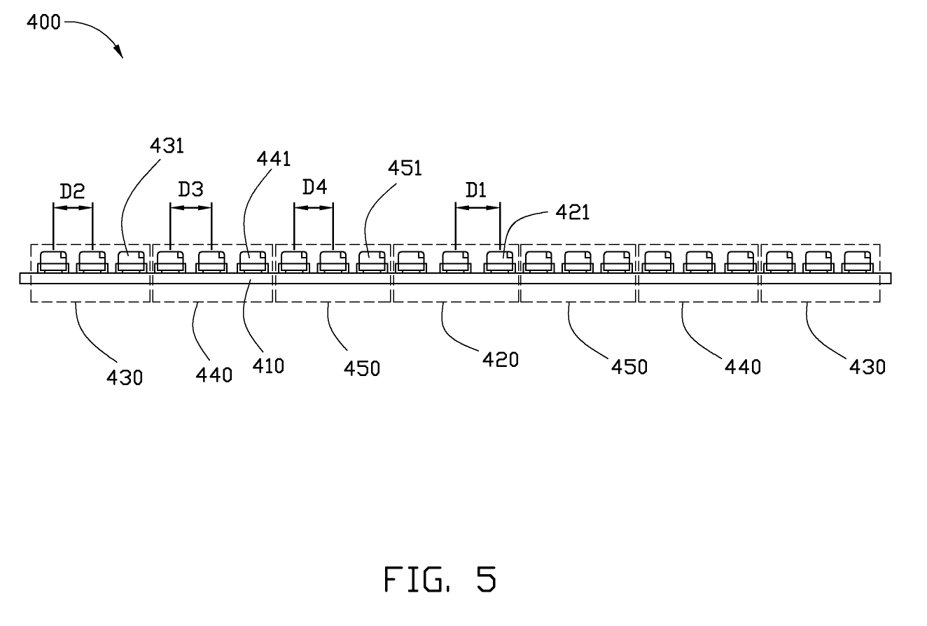

Referring to FIG. 5, an LED light bar 400 in accordance with a third embodiment includes a circuit board 410, a first lighting module 420, two second lighting modules 430, two third lighting modules 440 and two fourth lighting modules 450 on a surface of the circuit board 410. The first lighting module 420 includes a plurality of LEDs 421 and formed in the middle of the circuit board 410. Intervals between the LEDs 421 each are represented by D1. The two second lighting modules 430 include a plurality of LEDs 431 and formed at two opposite ends of the circuit board 410. Intervals between the LEDs 431 each are represented by D2. The third lighting modules 440 include a plurality of LEDs 441 and formed between the first lighting module 420 and the second lighting modules 430. Intervals between the LEDs 441 each are represented by D3. The fourth lighting modules 450 include a plurality of LEDs 451 and formed between the first lighting module 420 and the third lighting modules 440. Intervals between the LEDs 451 each are represented by D4. The LEDs 421, 431, 441 and 451 are arranged linearly on the circuit board 410 in accordance with the following relationships: D1>D3>D2 and D1>D3>D4.

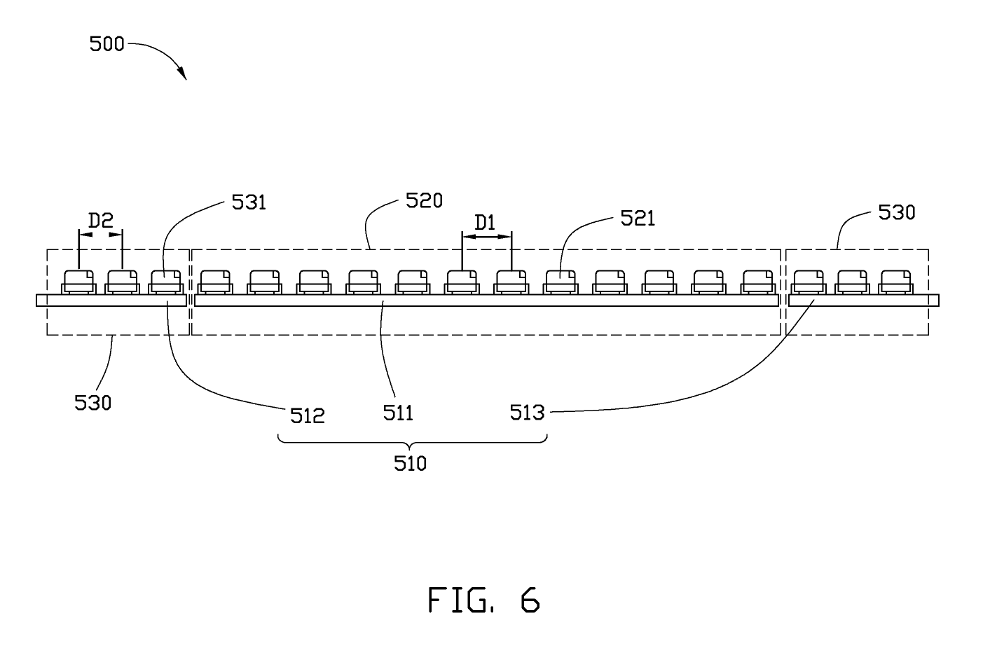

In alternative embodiments, the circuit board can consist of a plurality of separated circuit board units. Referring to FIG. 6, an LED light bar 500 includes an elongated circuit board 510, a first lighting module 520 and two second lighting modules 530 formed on a surface of the circuit board 510. The second lighting modules 530 include a plurality of LEDs 531. The first lighting module 520 includes a plurality of LEDs 521 and formed in the middle of the LED light bar 500. The two second lighting modules include a plurality of LEDs 531 and formed at the two opposite ends of the LED light bar 500. Intervals between the adjacent LEDs 521 each are larger than that between the adjacent LEDs 531. Different from the first embodiment, the circuit board 510 includes separated circuit board units 511, 512 and 513. The first lighting module 520 is formed on the surface of the circuit board unit 511 and the two second lighting modules 530 are formed on the surfaces of the circuit board units 512 and 513 respectively. If one part of the LED light bar 500 is damaged, only the damaged part is needed to be replaced.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED light bar comprising:
an elongated circuit board;
a first lighting module formed in a middle of the circuit board;
two second light modules respectively formed at two opposite ends of the circuit board;
wherein each of the first lighting module and the two second lighting modules comprises a plurality of LEDs arranged on a surface of the circuit board, and density of the LEDs in the first lighting module is smaller than that in the second lighting modules.

2. The LED light bar of claim 1, wherein the LEDs are arranged linearly on the surface of the circuit board.

3. The LED light bar of claim 2, wherein intervals between adjacent LEDs in the first lighting module are substantially the same.

4. The LED light bar of claim 3, wherein intervals between adjacent LEDs in the second lighting module are substantially the same.

5. The LED light bar of claim 4, wherein the intervals between adjacent LEDs in the first lighting module each are larger than that in the second lighting module.

6. The LED light bar of claim 1, further comprising two third lighting modules, each of the third lighting modules being formed between the first lighting module and one of the two second lighting modules, each third lighting module comprising a plurality of LEDs, intervals between the adjacent LEDs in the third lighting modules being smaller than that in the first lighting module and larger than that in the second lighting modules.

7. The LED light bar of claim 6, further comprising two fourth lighting modules, each of the fourth lighting modules being formed between the first lighting module and one of the two third lighting modules.

8. The LED light bar of claim 7, wherein intervals between adjacent LEDs in the fourth lighting modules each are smaller than that in the first lighting module.

9. The LED light bar of claim 7, wherein intervals between adjacent LEDs in the fourth lighting modules each are larger than that in the first lighting module.

10. The LED light bar of claim 1, wherein the circuit board define holes between the first lighting module and the second lighting modules.

11. The LED light bar of claim 1, wherein the circuit board comprises a first circuit board unit and two second circuit board units, the first circuit board unit is formed in the middle of the LED light bar and the two second circuit board units are formed at two opposite ends of the LED light bar, the first circuit board unit being separated from the second circuit board units.

12. The LED light bar of claim 11, wherein the first lighting module is formed on the first circuit board and the two second lighting modules are formed on the second circuit board units respectively.

13. The LED light bar of claim 1, wherein the LEDs arranged on the surface of the circuit board are in series connection or in parallel connection.

14. The LED light bar of claim 1, wherein circuit board is Al-based printed circuit board.

15. An LED light bar comprising a circuit board and a plurality of LEDs arranged linearly on a surface of the circuit board, wherein intervals between adjacent LEDs gradually decrease from a middle of the circuit board to two opposite ends of the circuit board.

16. The LED light bar of claim 15, wherein the LEDs are in parallel connection or in series connection.
